(19) United States
(12) Patent Application Publication
(10) Pub. No.: US 2009/0153568 A1
(43) Pub. Date: Jun. 18, 2009

(54) LOCOMOTION GENERATION METHOD AND APPARATUS FOR DIGITAL CREATURE

(75) Inventors: Il-Kwon Jeong, Daejeon (KR); Man Kyu Sung, Daejeon (KR); Byoung Tae Choi, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/034,500

(22) Filed: Feb. 20, 2008

(30) Foreign Application Priority Data
Dec. 18, 2007 (KR) 10-2007-0133675

(51) Int. Cl. G06T 13/00

(52) U.S. Cl. 345/474; 382/100

(57) ABSTRACT

A locomotion generation method for a digital creature includes: imaging and capturing movements of a creature placed on a base plate having a printed pattern; extracting body position information, body posture information, leg posture information, and footprint information of the creature by analyzing captured images; and generating creature movement by applying inverse kinematics to the body position information, the body posture information, the leg posture information, and the footprint information of the creature. The movements of the creature are imaged and captured by using two or more cameras without camera calibration

### FIELD OF THE INVENTION

The present invention relates to locomotion generation of a digital creature; and, more particularly, to a method and apparatus for generating locomotion of a digital creature including a small-sized insect by using cameras without camera calibration.

This work was supported by the IT R&D program of MIC/IITA. [2007-S-051-01, Software Development for Digital Creature]

### BACKGROUND OF THE INVENTION

In recent movies, the use of computer graphics is ever increasing. Computer graphics are used to represent humans, imaginary creatures such as dragons, and animals such as lions and mice. Digital creatures denote creatures represented by computer graphics.

In a movie, a digital creature is so photorealistic that it is hard to distinguish it from a real creature. A digital creature can be used to produce difficult or dangerous actions that cannot be performed by a real animal, or freely design actions by an intention of the director.

To enhance a realistic feeling in a movie, it is essential to generate and display a photorealistic appearance of a digital creature and natural motion thereof. For a human, a manual process such as keyframing was used to generate a motion in the past. However, in recent filmmaking, motion capture is being used to extract movements of a human by imaging and tracking a human actor attached thereon a marker set. In particular, optical motion capture systems are normally used.

For animals, an optical motion capture system may be used to capture movements of a big-sized and tamed animal such as a horse or an elephant. However, in most cases, an animator manually generates movements of an animal through keyframing based on video images of a real animal. This process consumes a large amount of time and may not fully reflect specific characteristics of a creature.

Motion capture is hard to be applied to a fierce or dangerous animal, and, particularly, to a small-sized object such as an ant or spider which cannot be attached thereon a marker. There also exists marker-free motion capture using cameras and image processing only. However, the marker-free motion capture is poorer in precision and resolution than optical motion capture, and therefore is not adequate for acquiring movements of a small-sized object like an insect. Further, conventional motion capture systems require preprocessing such as camera calibration, capture volume control, or the like. Accordingly, it would be desirable to provide a technical means to acquire movements of a creature without these problems.

### SUMMARY OF THE INVENTION

In view of the above, the present invention provides a locomotion generation method and apparatus capable of generating locomotion of a small-sized digital creature such as an insect without performing motion capture or calibration by an animator, wherein information on a body and footprints of a creature is extracted using two or more cameras and a base plate having a printed pattern, and leg movement is generated using the extracted information.

In accordance with an aspect of the present invention, there is provided a locomotion generation method for a digital creature, including:

imaging and capturing movements of a creature placed on a base plate having a printed pattern;

extracting body position information, body posture information, leg posture information, and footprint information of the creature by analyzing captured images; and

generating creature movement by applying inverse kinematics to the body position information, the body posture information, the leg posture information, and the footprint information of the creature.

In accordance with another aspect of the present invention, there is provided a locomotion generation apparatus for a digital creature, comprising:

an imaging and capturing unit for imaging and capturing movements of a creature placed on a base plate having a printed pattern;

a data extraction unit for extracting body position information, body posture information, leg posture information, and footprint information of the creature by analyzing captured images; and

a motion generation unit for generating creature movement by applying inverse kinematics to the body position information, the body posture information, the leg posture information, and the footprint information of the creature.

In accordance with the present invention, locomotion of a small-sized digital creature such as an ant or spider can be readily generated through imaging by using two or more cameras without camera calibration, image processing, and post-processing using inverse kinematics. This solves two problems: inapplicability of conventional motion capture due to difficulty of marker attachment, and inefficiency and inaccuracy of locomotion generation in manual. Compared with a conventional motion capture system, information volume generated according to the present invention may be somewhat insufficient because extraction of movements is limited to legs. However, a crawling creature has leg movements only, which are relatively simple. Hence, the extracted information according to the present invention is sufficient to create a movement animation of such a creature. For some applications, the present invention may be applied to human walking movement generation. Generation of creature locomotion according to the present invention is expected to be widely applicable to production of various contents such as movies, animations, and games that process small-sized insects using computer graphics.

### BRIEF DESCRIPTION OF THE DRAWINGS

The above features of the present invention will become apparent from the following description of embodiments given in conjunction with the accompanying drawings, in which:

FIG. 1 illustrates a schematic block diagram of a locomotion generation apparatus for a digital creature in accordance with an aspect of the present invention;

FIG. 2 illustrates a flow chart of a locomotion generation method for a digital creature in accordance with another aspect of the present invention;

FIG. 3 illustrates a conceptual diagram of a base plate having a printed pattern and cameras for extracting footprints in accordance with the present invention;

FIG. 4 illustrates a conceptual diagram for explaining two-segment inverse kinematics for creature locomotion generation in accordance with the present invention; and

FIGS. 5A and 5B respectively illustrate a conceptual diagram for explaining a virtual two-segment structure for creature locomotion generation in accordance with the present invention.

### DETAILED DESCRIPTION OF THE EMBODIMENTS

Hereinafter, embodiments of the present invention will be described in detail with reference to the accompanying drawings, which form a part hereof.

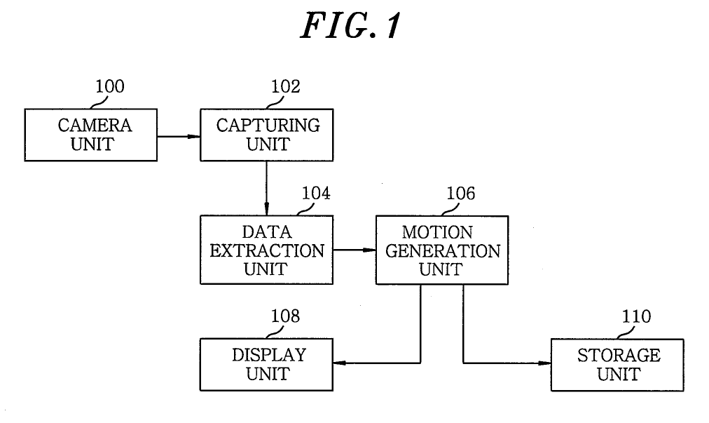

FIG. 1 illustrates a schematic block diagram of a locomotion generation apparatus for a digital creature in accordance with an aspect of the present invention. The locomotion generation apparatus includes a camera unit 100, a capturing unit 102, a data extraction unit 104, a motion generation unit 106, a display unit 108, and a storage unit 110.

The camera unit 100 images an imaging object, i.e., a creature. Here, the creature to be imaged is an insect-like creature, e.g., an ant, which is small-sized and moves on or close to the ground.

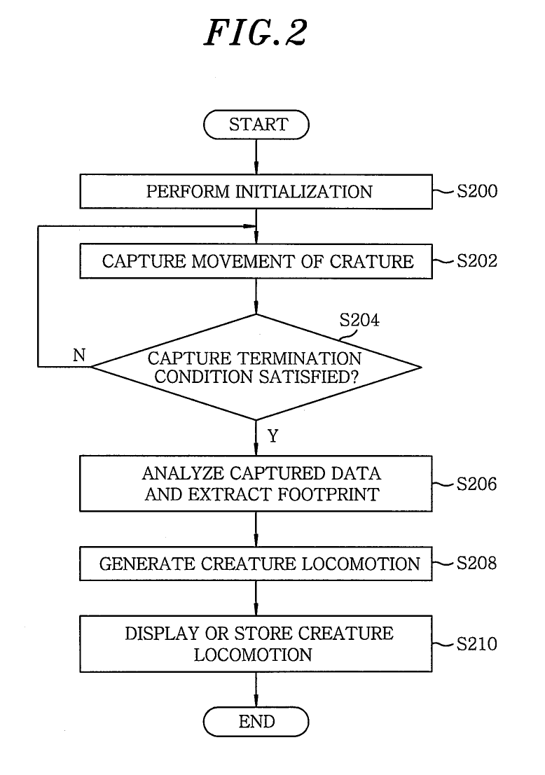

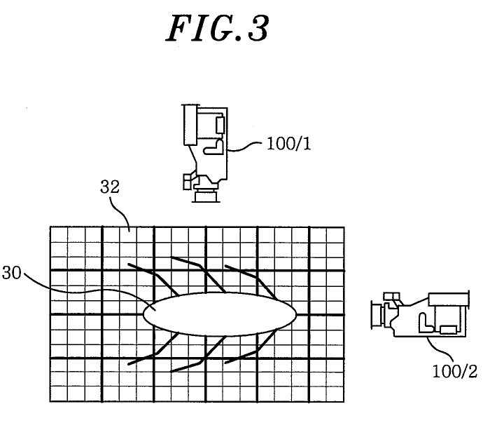

The capturing unit 102 captures and stores creature images taken by the camera unit 100. The camera unit 100 and the capturing unit 102 can be implemented as a single functional block. The functional block images a creature on a base plate having a printed pattern by using two or more cameras, and captures and stores the creature images. The camera unit 100 and the capturing unit 102 will be described in detail in connection with FIGS. 2 and 3.

The data extraction unit 104 extracts data necessary for creature locomotion generation from creature images captured by the capturing unit 102. That is, the data extraction unit 104 analyzes the captured creature images, and extracts creature movement data, e.g., footprint data of the creature.

The motion generation unit 106 generates creature locomotion using the creature movement data extracted by the data extraction unit 104. Here, a leg of a small-sized creature like an insect can be generally represented by two joints. Creature locomotion generation will be described in detail in connection with FIGS. 2, 4 and 5A and 5B.

The display unit 108 displays visual information (creature movement images) output from the motion generation unit 106. The display unit 108 may include an LCD (Liquid Crystal Display) driving unit.

The storage unit 110 stores the creature movement images output from the motion generation unit 106, and can also temporarily store the creature images captured by the capturing unit 102.

FIG. 2 illustrates a flow chart of a locomotion generation method for a digital creature in accordance with another aspect of the present invention.

In an initialization step (step S200), a creature joint structure is created, camera positions are set for imaging, and a real creature as an imaging object and a base plate having a printed pattern are prepared. In a creature movement capture step (step S202), creature images are captured using at least two synchronized cameras and stored in the storage unit 110.

FIG. 3 illustrates a conceptual diagram of a base plate having a printed pattern and cameras for extracting footprints in accordance with the present invention.

A footprint is defined as a contact point between the base plate and an end of a leg of a moving target creature.

In FIG. 3, reference numerals 30 and 32 represent a target creature to be imaged for locomotion generation and a base plate having a printed grid-pattern, respectively. Further, reference numerals 100/1 and 100/2 represent a first camera installed so as to vertically face the base plate 32 from the ceiling and a second camera installed so as to horizontally face the target creature 30 at the same elevation as the base plate 32, respectively.

In the present invention, it is assumed that the target creature 30 is restricted to move on or close to the base plate 32, for the purpose of locomotion generation. This assumption is applicable to crawling insects such as ants, spiders, cockroaches, and the like.

The printed pattern of the base plate 32 is for tracking positions of footprints without camera calibration. In this embodiment, the printed pattern is a grid-shaped pattern, as shown in FIG. 3.

A conventional optical motion capture system performs camera calibration prior to image capture. Through the calibration, 3-dimensional information of a marker can be obtained using trigonometry and images taken by two or more cameras tracking the marker.

However, the target creature 30 of the present invention may be too small to be attached thereon a marker. If the target creature 30 is small-sized, capture volume becomes small, and the difference between positions of real footprints and those of calculated footprints tends to become large. In accordance with the present invention, in consideration of the fact that ends of legs of an insect-like creature remain close to the base plate 32, the positions of footprints are easily and accurately obtained by comparing the printed pattern of the base plate 32 with creature outlines and feature points in images taken by the cameras 100/1 and 100/2.

In the present embodiment, the base plate 32 has a printed grid-pattern for the simplicity of explanation. However, the shape of the pattern is not limited thereto, and may be one of various patterns including a colored pattern, a numbered pattern, and the like. As for the numbered pattern, a user can write numbers in the pattern, which may help the user to perform additional manual works on captured images.

The first camera 100/1 images the target creature 30 from the ceiling. The images captured by the first camera 100/1 are used in extracting a body position, a body posture, a leg posture, and candidate footprint positions of the target creature 30 projected on the base plate 32.

The second camera 100/2 images the target creature 30 at the same elevation as the base plate 32, and the images captured by the second camera 100/2 are used in extracting footprints. To be specific, an end of a leg of the target creature 30 is regarded as a footprint when the end of the leg contacts the base plate 32 or the height of the end of the leg is below a specific value.

In addition to the first and the second camera 100/1 and 100/2, one or more cameras may be employed. That is, it is to be noted that the number of cameras can be increased to facilitate imaging and motion capture, and to enhance capture accuracy.

Because camera calibration is unnecessary in the present invention, imaging can be performed while a user moves with a camera held in his/her hands. However, auxiliary aids can be used to obtain more stable images.

Further, close-up lenses can be placed at the first and the second camera 100/1 and 100/2 for more effective imaging of a very small-sized creature. Because camera calibration is unnecessary, any device contributing to clear imaging of the target creature 30 can be used without the worry of image distortion.

Referring back to FIG. 2, a capture termination condition check step (step S204) is performed, whenever the step S202 (creature movement capture step) has been performed. In the step S204 (capture termination condition check step), it is determined whether a preset number of frames have been imaged or a preset time duration has been elapsed from the start of an imaging. If it is determined that the capture termination condition is satisfied, imaging and capturing of the creature movement are terminated.

In a capture data analysis and footprints extraction step (step S206), data for creature movement generation is extracted.

First, a body position, a body posture, a leg posture, and candidate footprint positions of the target creature 30 orthogonally projected onto the base plate 32 are extracted from each frame of the top view image taken by the first camera 100/1. Those skilled in the art of image processing can readily perform this process without restriction in details of the process. For example, the body of the target creature 30 can be detected using the base plate 32 having a color in contrast to that of the target creature 30, and the legs can be detected through edge or line detection technique. Here, ends of the legs correspond to candidate footprint positions.

Since a pattern is printed on the base plate 32, the shape and position of the pattern can be detected through simple image processing, and, positions of parts of the target creature 30 are determined using size and shape information of the pattern identified in advance.

Although obtained images may contain distortions due to the lack of camera calibration, the use of a densely printed pattern and pre-identified information on the pattern can substantially prevent position extraction errors due to the image distortions. This is because the position of each part of the target creature 30 is calculated relative to nearby feature points of the pattern. If an extracted position is between feature points of the pattern, the position can be corrected through simple linear interpolation. The use of a densely printed pattern can also substantially prevent position extraction errors in the interpolation.

Next, positions of footprints are determined through analysis of images taken by the second camera 100/2. A footprint is defined as a contact point between an end of a leg and the base plate 32. The height of the creature body and candidate footprint positions are detected from images taken at the same elevation of the base plate 32 by the second camera 100/2, wherein the images are analyzed in a similar manner to the case of the first camera 100/1. Lack of a reference background like the base plate 32 having a printed pattern and lack of camera calibration may make it difficult to extract an absolute height of an end of a leg from the ground. This difficulty can be overcome by the use of a background having a pattern like that of the base plate 32 when images are taken by the second camera 100/2. Alternatively, the absolute height can be obtained by measuring, in the images, a relative value of the height of the end of the leg from the ground with respect to an actually measured size of the body or parts of the target creature 30.

A leg of the target creature 30 in motion repeatedly steps on the base plate 32. Accordingly, a position of a candidate footprint (horizontal position of an end of a leg) is traced along consecutive image frames, and the candidate footprint is determined as a footprint when the end of the leg is closest to the base plate 32 or its height from the ground is below a preset minimum value. In addition, a candidate footprint position is recorded when an end of a leg is farthest from the base plate 32 in a movement cycle, for locomotion generation to be described later.

In a creature locomotion generation step (step S208), creature locomotion is generated using data extracted in the step S206 (capture data analysis and footprints extraction step). Here, a leg of a small-sized creature like an insect can be represented by two joints.

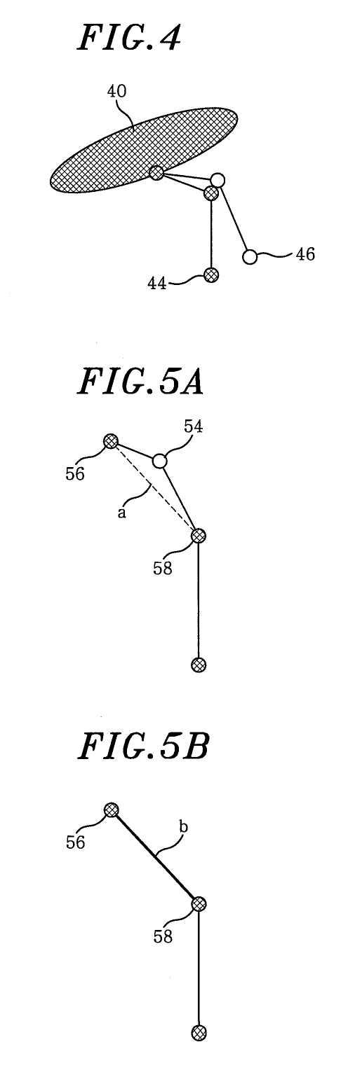

FIG. 4 illustrates a conceptual diagram for explaining two-segment inverse kinematics for creature locomotion generation in accordance with the present invention. In FIG. 4, reference numerals 40, 44, and 46 respectively represent a target creature, a current leg-end position of the target creature 40, and a target leg-end position of the target creature 40.

When the target leg-end position 46 is given, a new leg posture can be determined through two-segment inverse kinematics. Any known strategy of two-segment inverse kinematics can be applied to this problem. However, commonly to strategies of two-segment inverse kinematics, only a single position (unique solution) of a middle joint between a body and an end of a leg needs to be determined among multiple solutions (multiple points on a concentric circle obtained by rotating the middle joint in a state where the body and the end of the leg are fixed).

The unique solution of two-segment inverse kinematics can be determined using a leg posture extracted from images taken by the first camera 100/1 in the step S206.

For a creature having a leg of three or more segments, inverse kinematics involving multi-segment may be applied. As for an insect-like creature, unlike a human, the rotation range of a leg joint is very narrow. Compared with a two-segment inverse kinematics problem, an inverse kinematics problem involving a multi-joint structure of three or more segments is more complex and takes more time to solve. In consideration of these, a virtual two-segment structure can be used in determining a new leg posture, in which a representative joint having the widest motion range is regarded as a middle joint and a unique solution of the middle joint is obtained as described in connection with FIG. 4.

FIGS. 5A and 5B respectively illustrate a conceptual diagram for explaining a virtual two-segment structure for creature locomotion generation in accordance with the present invention. In FIG. 5A, reference numerals 54, 56 and 58 represent three joints of a leg of a creature having three-segment legs. If the joint 58 is a representative joint, the straight line a connecting the joints 56 and 58 becomes a virtual segment. Hence, the three-segment leg of FIG. 5A can be transformed into a two-segment leg including a virtual segment b of FIG. 5B, which can be handled as described in connection with FIG. 4.

In locomotion generation using inverse kinematics, frames having a footprint and frames having an end of a leg at the highest position in a movement cycle can be set as keyframes, to which inverse kinematics is applied. Setting keyframes as described above minimizes the number of keyframes. Of course, additional keyframes may be set using analysis results of images taken by the first and the second camera 100/1 and 100/2.

Animation between keyframes can be made by using any conventional keyframing technique, e.g., interpolation synthesis of articulated-figure motion using quaternions. At this time, each leg of the target creature 30 needs to be animated separately from other parts of the target creature 30 and then merged into the entire locomotion animation of the target creature 30. This is because, if the legs are keyframed together with other parts of the target creature 30, posture determination in keyframing is not easy for a leg that does not reach a position corresponding to a footprint or the highest position thereof.

The base plate 32 may have a slanted surface. At this case, in determining the position corresponding to a footprint, heights given at pattern parts and the fact that a leg is hidden in images taken by the camera 100/2 by the slanted surface need to be considered. Except for the above differences, descriptions given to the base plate 32 having a horizontal surface are also applicable to the base plate 32 having a slanted surface.

Referring back to FIG. 2, in a screen display or storage step (step S210), locomotion created in the step S210 is displayed on the display unit 108 or stored in the storage unit 110.

As described above, the present invention provides a locomotion generation method and apparatus for a digital creature, wherein locomotion of a small-sized creature such as an ant or a spider can be readily generated, without camera calibration, through image capturing by two or more cameras, image processing, and inverse kinematics post-processing.

While the invention has been shown and described with respect to the embodiments, it will be understood by those skilled in the art that various changes and modifications may be made without departing from the scope of the invention as defined in the following claims.

What is claimed is:

1. A locomotion generation method for a digital creature, comprising:
imaging and capturing movements of a creature placed on a base plate having a printed pattern;
extracting body position information, body posture information, leg posture information, and footprint information of the creature by analyzing captured images; and
generating creature movement by applying inverse kinematics to the body position information, the body posture information, the leg posture information, and the footprint information of the creature.

2. The locomotion generation method of claim 1, wherein the movements of the creature are imaged and captured by using two or more cameras without camera calibration.

3. The locomotion generation method of claim 1, wherein extracting information includes:
detecting the body position information and the body posture information of the creature by using the printed pattern of the base plate having a color in contrast to that of the creature;
detecting the leg posture information of the creature by using edge or line detection technique; and
detecting the footprint information by using the leg posture information.

4. The locomotion generation method of claim 3, wherein in detecting the footprint information, a horizontal position of an end of each leg of the creature on the base plate is regarded as a candidate footprint position and determined as a footprint position when the end of the leg contacts the base plate.

5. The locomotion generation method of claim 1, wherein in generating creature movement, two-segment inverse kinematics is applied if a leg of the creature has two joints.

6. A locomotion generation apparatus for a digital creature, comprising:
an imaging and capturing unit for imaging and capturing movements of a creature placed on a base plate having a printed pattern;
a data extraction unit for extracting body position information, body posture information, leg posture information, and footprint information of the creature by analyzing captured images; and
a motion generation unit for generating creature movement by applying inverse kinematics to the body position information, the body posture information, the leg posture information, and the footprint information of the creature.

7. The locomotion generation apparatus of claim 6, wherein the imaging and capturing unit images and captures the movements of the creature by using two or more cameras without camera calibration.

8. The locomotion generation apparatus of claim 7, wherein the two or more cameras includes:
one or more first cameras vertically facing the base plate; and
one or more second cameras horizontally facing the creature at the same height as the base plate.

9. The locomotion generation apparatus of claim 8, wherein the data extraction unit determines, by using images taken by the second cameras, a horizontal position of each end of a leg of the creature on the base plate as a footprint position, when the end of the leg contacts the base plate or the height of the end of the leg is below a specific value.

10. The locomotion generation apparatus of claim 6, wherein the data extraction unit has size and shape information of the printed pattern of the base plate and uses the size and shape information in detecting the footprint information.
